(19) United States
(12) Patent Application Publication
(10) Pub. No.: US 2007/0041321 A1
(43) Pub. Date: Feb. 22, 2007

(54) Network switch apparatus that avoids congestion at link-aggregated physical port

(75) Inventors: Hiroyuki Sasaki, Kawasaki (JP); Masayuki Sato, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/315,945

(22) Filed: Dec. 22, 2005

(30) Foreign Application Priority Data
Aug. 17, 2005 (JP) 2005-236934

(51) Int. Cl. H04J 1/16; H04L 12/56

(52) U.S. Cl. 370/235; 370/412

(57) ABSTRACT

A network switch apparatus which receives data at physical input ports and outputs the data from a plurality of link-aggregated physical output ports includes a distribution processing unit configured to receive data input at one of the physical input ports and to assign the input data to one of the physical output ports for outputting therefrom such that the one of the physical output ports is determined according to part of the input data, and a queue utilization monitoring unit configured to monitor a utilization rate of a queue provided separately for each of the physical output ports and to send an alarm to the distribution processing unit in response to the utilization rate of the queue exceeding a predetermined threshold, wherein the distribution processing unit is configured to assign the input data to the one of the physical output ports for which the alarm is not reported.

### BACKGROUND OF THE INVENTION

1. Field of the Invention

The present invention generally relates to network switch apparatuses, and particularly relates to a network switch apparatus which receives data input at physical ports and assigns the data to a plurality of physical ports for outputting which are link-aggregated.

2. Description of the Related Art

Link aggregation defined in IEEE802.3ad is designed for use as a technology that increases physical bandwidth. In carrier networks, link aggregation is often used as redundancy technology.

Link aggregation serves to group physical links 3, 4, 5 into a single logical link 6 between network switch apparatuses 1 and 2 as shown in FIG. 1.

When data needs to be output from a link-aggregated trunk (i.e., logical port into which physical ports are aggregated), Hash computation is performed on the side where physical data-input ports are situated. Then, the physical ports of the trunk are selected such that data of the same flow (having the same destination address and the same source address) are output from the same physical port.

Patent Document 1 discloses putting up a flag to request an action by an available channel when it becomes impossible to process traffic in some of the plurality of channels.

Patent Document 2 discloses using the bandwidth of a detour channel when the bandwidth of the link-aggregated channel becomes insufficient.

[Patent Document 1] Japanese Patent Application Publication No. 57-41055

[Patent Document 2] Japanese Patent Application Publication No. 2003-244200

Related-art network switches select physical ports such that data of the same flow is output from the same physical port of the trunk. If the Hash computation produces a large number of data flows for which a particular physical port is selected as an output port among the plurality of physical ports of the trunk, there is a risk of causing congestion at this particular physical port despite the fact that the other physical ports in the trunk are available.

A priority control service may be provided by use of three classes comprised of the highest priority, a high priority, and a low priority, for example. In such a case, data of the same flow having the highest priority are assigned to a particular physical port that is selected by Hash computation to serve as an output port among the plurality of physical ports of the trunk. Despite the fact that a storage area for data of the highest priority is available in the other physical ports of the trunk, the data having the highest priority may suffer congestion at the particular physical port.

Accordingly, there is a need for a network switch apparatus that can reduce congestion at a particular physical port in a trunk.

### SUMMARY OF THE INVENTION

It is a general object of the present invention to provide a network switch apparatus that substantially obviates one or more problems caused by the limitations and disadvantages of the related art.

Features and advantages of the present invention will be presented in the description which follows, and in part will become apparent from the description and the accompanying drawings, or may be learned by practice of the invention according to the teachings provided in the description. Objects as well as other features and advantages of the present invention will be realized and attained by a network switch apparatus particularly pointed out in the specification in such full, clear, concise, and exact terms as to enable a person having ordinary skill in the art to practice the invention.

To achieve these and other advantages in accordance with the purpose of the invention, the invention provides a network switch apparatus which receives data at physical input ports and outputs the data from a plurality of link-aggregated physical output ports, said network switch apparatus including a distribution processing unit configured to receive data input at one of the physical input ports and to assign the input data to one of the physical output ports for outputting therefrom such that said one of the physical output ports is determined according to part of the input data, and a queue utilization monitoring unit configured to monitor a utilization rate of a queue provided separately for each of the physical output ports and to send an alarm to said distribution processing unit in response to the utilization rate of the queue exceeding a predetermined threshold, wherein said distribution processing unit is configured to assign the input data to the one of the physical output ports for which said alarm is not reported.

According to another aspect of the present invention, a network switch apparatus which receives data at physical input ports and outputs the data from a plurality of link-aggregated physical output ports includes a distribution processing unit configured to receive data input at one of the physical input ports and to assign the input data to one of the physical output ports for outputting therefrom such that said one of the physical output ports is determined according to part of the input data, and an output signal rate computing unit configured to compute an output signal rate of said one of the physical output ports and to notify said distribution processing unit of the computed output signal rate, wherein said distribution processing unit is configured to assign the input data to the one of the physical output ports for which said computed output signal rate is less than a predetermined proportion of a maximum output signal rate of said one of the physical output ports.

According to another aspect of the present invention, a network switch apparatus which receives data at physical input ports and outputs the data from a plurality of link-aggregated physical output ports includes a distribution processing unit configured to receive data input at one of the physical input ports and to assign the input data to one of the physical output ports for outputting therefrom such that said one of the physical output ports is determined according to part of the input data, a queue utilization monitoring unit configured to monitor a utilization rate of a queue provided separately for each of the physical output ports, and a queue utilization comparing unit configured to compare, between the physical output ports, the utilization rate of the queue reported from said queue utilization monitoring unit, and to notify said distribution processing unit of a physical output port having a lowest utilization rate, wherein said distribution processing unit is configured to assign the input data to the one of the physical output ports that is the physical output port having the lowest utilization rate.

According to at least one embodiment of the present invention, congestion is reduced at a particular physical port in the trunk.

### BRIEF DESCRIPTION OF THE DRAWINGS

Other objects and further features of the present invention will be apparent from the following detailed description when read in conjunction with the accompanying drawings, in which:

FIG. 1 is an illustrative drawing for explaining link aggregation;

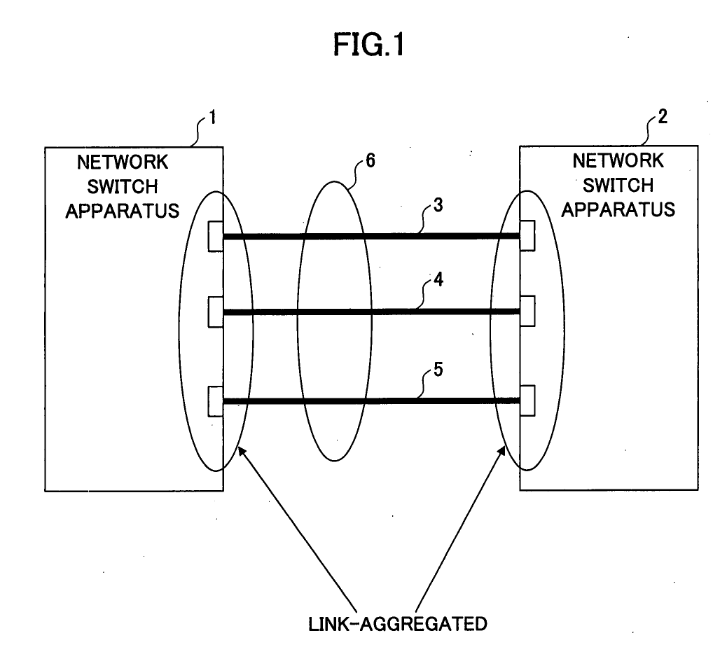

FIG. 2 is a drawing showing the configuration of an embodiment of a wide-area network system to which the present invention is applied;

FIG. 3 is a block diagram showing a first embodiment of a network switch apparatus;

FIG. 4 is a drawing showing a VLAN tag header format;

FIG. 5 is a flowchart showing a first embodiment of the distribution process performed by a distribution processing unit;

FIG. 6 is a flowchart showing a second embodiment of the distribution process performed by the distribution processing unit;

FIG. 7 is a block diagram showing a third embodiment of the network switch apparatus;

FIG. 8 is a flowchart showing a third embodiment of the distribution process performed by the distribution processing unit;

FIG. 9 is a block diagram showing a fourth embodiment of the network switch apparatus; and

FIG. 10 is a flowchart showing a fourth embodiment of the distribution process performed by the distribution processing unit.

### DESCRIPTION OF THE PREFERRED EMBODIMENTS

In the following, embodiments of the present invention will be described with reference to the accompanying drawings.

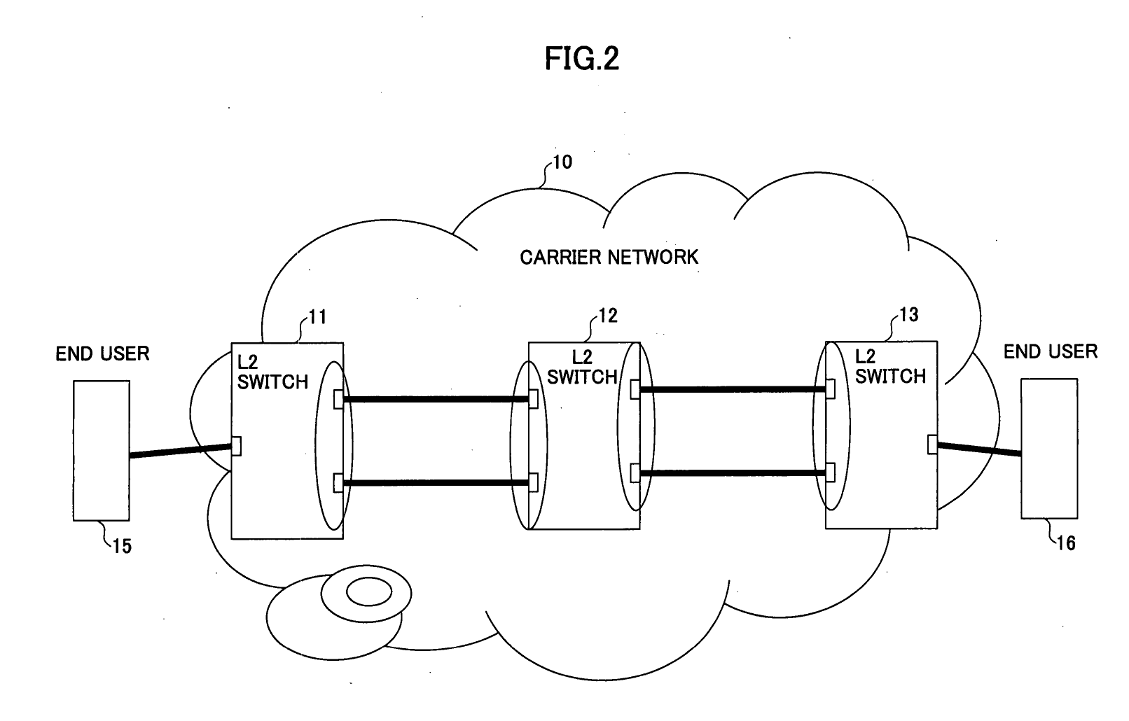

FIG. 2 is a drawing showing the configuration of an embodiment of a wide-area network system to which the present invention is applied. In FIG. 2, a carrier network 10 is formed via a mesh topology or tree topology by network switch apparatuses 11, 12, and 13 serving as Layer-2 switches, for example. Each of the network switch apparatuses 11 and 13 of the carrier network 10 are connected to end users 15 and 16, respectively.

This configuration can provide a service that transfers Layer-2 MAC frames of a subscriber LAN or the like from the end user 15 to another end user 16 via the network switch apparatuses 11, 12, and 13.

If Layer-3 switches are used in place of the Layer-2 switches, the IP (Internet Protocol) protocol may be used to provide a similar service.

The network switch apparatuses 11, 12, and 13 are link-aggregated in order to increase the physical bandwidth. Another purpose is to secure a detour route for data when a failure occurs along a transmission path in the network.

### First Embodiment

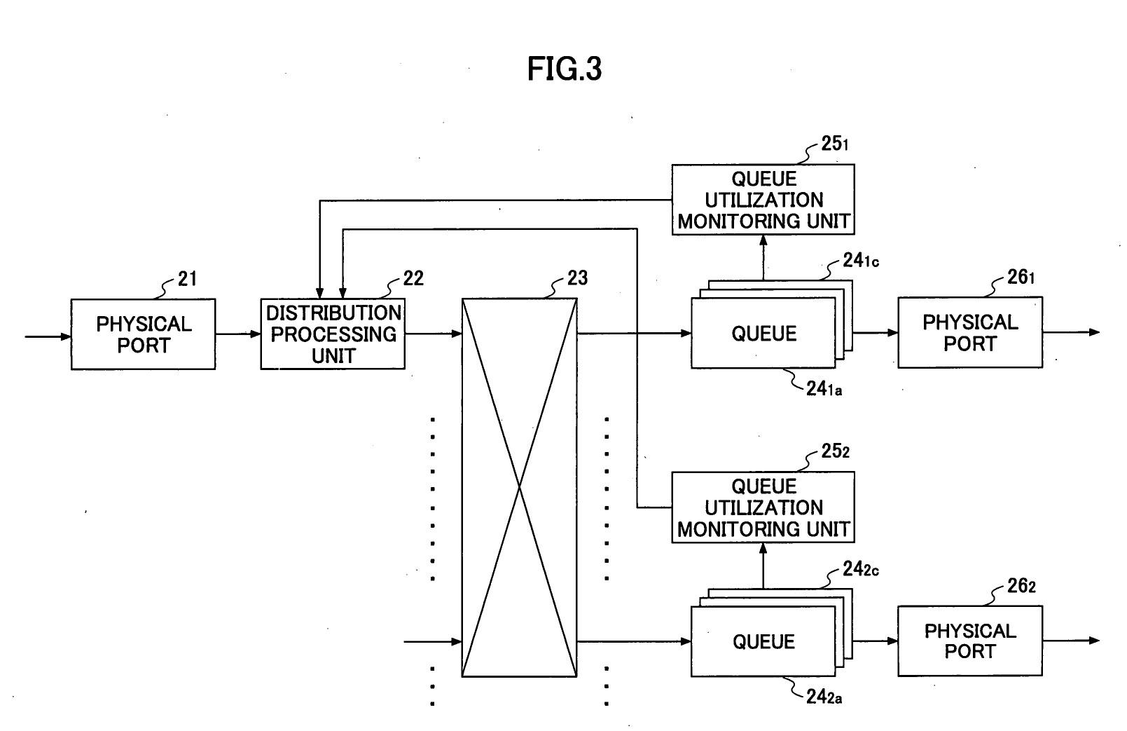

FIG. 3 is a block diagram showing a first embodiment of a network switch apparatus. In FIG. 3, a physical port 21 receives frames from an end user or another network switch apparatus. The physical port 21 supplies the received frames to a distribution processing unit 22. If the frames are supplied from the end user, the physical port 21 generates and attaches a VLAN tag (i.e., Virtual Local Area Network tag). FIG. 3 illustrates only the physical port 21 as an input port. In actuality, however, a plurality of physical ports are provided as input ports.

The distribution processing unit 22 selects output ports by performing Hash computation on the input frames. The distribution processing unit 22 attaches to the frames a switching tag for indicating an output port, and supplies the frames to a switch unit 23.

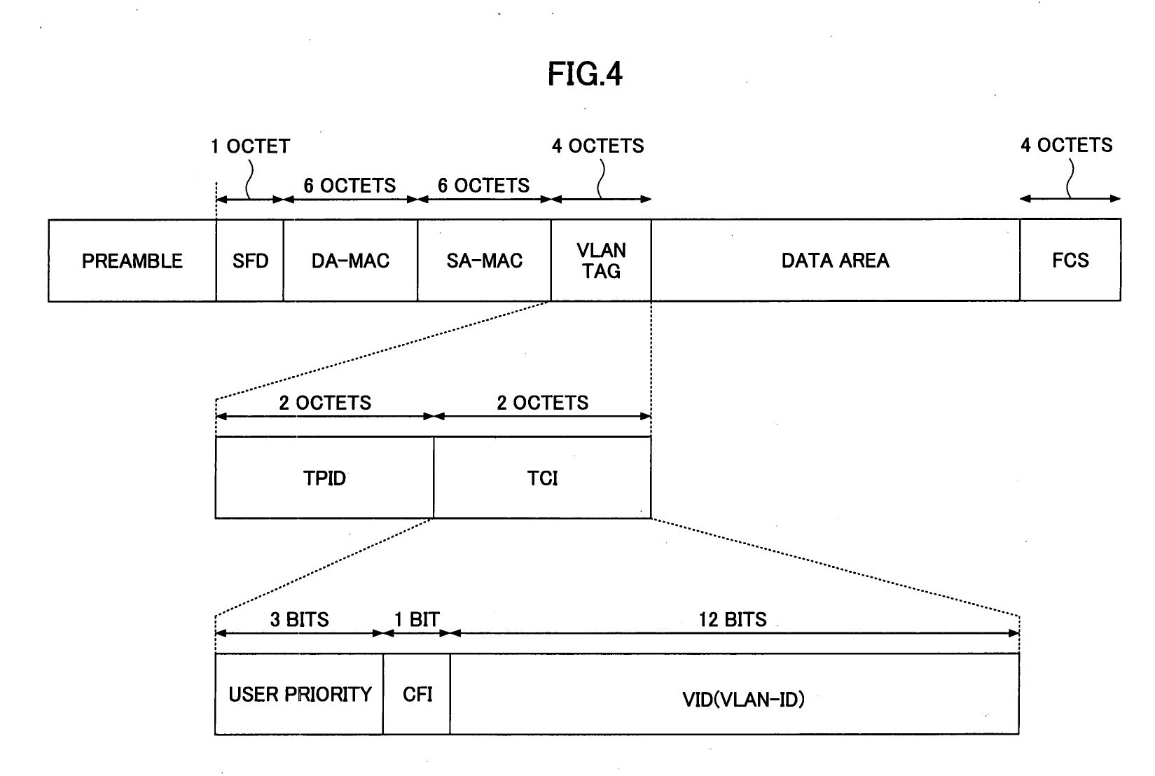

As a method for performing the Hash computation, a first method performs Hash computation with respect to a destination IP address and source IP address in the data area as well as DA-MAC (MAC destination address) and SA-MAC (MAC source address) in the VLAN tag header format defined in IEEE802.1Q as shown in FIG. 4. A second method performs Hash computation with respect to VID (VLAN-ID: ID of a source-side end user) of the VLAN tag header.

According the VLAN tag header format shown in FIG. 4, a 3-bit user priority, a 1-bit CFI (Canonical Format Indicator), and a 12-bit VID are provided in the TCI (Tag Control Information) of the VLAN tag. The user priority assumes values 6 and 7 to indicate the highest priority class, values 4 and 5 to indicate a high priority class, and values 0 through 3 to indicate a low priority class. Further, the values 6, 4, 2, and 0 indicate no preferential disposal, and the values 7, 5, 3, and 1 indicate preferential disposal.

When link aggregation configuration is implemented, a plurality of output ports are assigned with respect to the results of the Hash computation described above. In FIG. 3, two physical ports 26₁ and 26₂ are link-aggregated with respect to the results of predetermined Hash computation. In FIG. 3, only the physical ports 26₁ and 26₂ are illustrated as output ports. In reality, three or more physical ports are provided as output ports.

The switch unit 23 performs switching of frames by referring to the switching tags, and supplies the frames to queues provided separately for each of the physical output ports. The queues are provided in one-to-one correspondence to the plurality of priority classes. The frames supplied to the physical ports 26₁ and 26₂ by the switch unit 23 are queued in the queues 24₁ₐ through 24_{1c} and queues 24₂ₐ through 24_{2c} before being supplied to the physical ports 26₁ and 26₂.

The queues 24₁ₐ through 24₂ₐ serve to store frames having the highest priority class (e.g., audio data or the like). The queues 24_{1b} through 24_{2b} serve to store frames having the high priority class (e.g., business-purpose data or the like). The queues 24_{1c} through 24_{2c} serve to store frame having the low priority class (e.g., personal data or the like).

The frames queued in the queues 24₁ₐ through 24_{1c} are output from the physical port 26₁ in the descending order of priority classes (i.e., in the following order: 24₁ₐ, 24_{1b}, 24_{1c}). The same applies in the case of the other physical ports serving as output ports. When the frames are output from the physical ports, the switching tags attached to the frames by the distribution processing unit 22 are detached in one case, and are kept attached in another case for switching by switches at the subsequent stages.

The queues provided separately for each physical port are provided with a queue utilization monitoring unit. Queue utilization monitoring units 25₁ and 25₂ monitor the utilization rates of the queues 24₁ₐ through 24_{1c} and the queues 24₂ₐ through 24_{2c}, respectively. If the utilization rate of any priority class exceeds a first threshold such as approximately 80%, a remaining quantity alarm is issued, and is reported with an indication of priority class to the distribution processing unit 22.

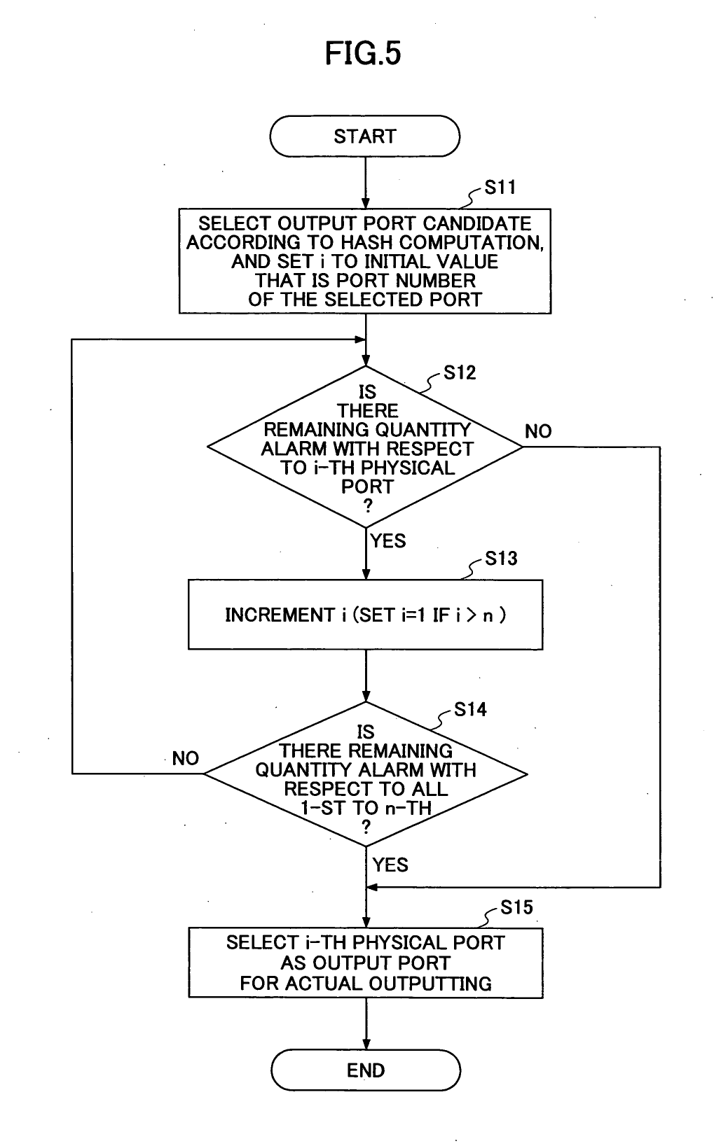

FIG. 5 is a flowchart showing a first embodiment of the distribution process performed by the distribution processing unit 22. This process is carried out each time a frame is input.

In FIG. 5, at step S11, Hash computation of the input frame is performed to derive an output port candidate. If link aggregation is put in place, n output ports are assigned to the result of the Hash computation. If one trunk is comprised of two physical ports, for example, n physical ports (n=2) are assigned as output ports. That is, “n” indicates the number of physical ports that are link-aggregated.

Here, sequence numbers 1 and 2 are assigned as the identifiers of the two physical ports that are link-aggregated. In this example, it is assumed that the Hash computation results in the physical port having sequence number 2 being selected as an output port candidate.

The distribution processing unit 22 sets a variable i to the initial value that is the sequence number of the physical port selected as the output port candidate by the Hash computation. In this example, i=2 because sequence number 2 corresponds to the output port candidate.

At step S12, a check is made as to whether a remaining quantity alarm for the queue of the priority class corresponding to the user priority indicated in the VLAN tag header of the input frame has been received from the queue utilization monitoring unit corresponding to the i-th physical port. If the remaining quantity alarm has been received, the variable i is incremented (i=i+1) at step S13. If i becomes larger than n as a result of the incrementing, i is set to 1.

In this example, i becomes 3 as a result of the incrementing, which satisfies i>n, so that i is set to 1.

At step S14, a check is made as to whether a remaining quantity alarm for the queue of the priority class corresponding to the user priority indicated in the VLAN tag header of the input frame has been received from all the 1st to n-th physical ports. If a remaining quantity alarm has been received from all the 1st to n-th physical ports (i.e., from all the queue utilization monitoring units), the procedure proceeds to step S15. Otherwise, the procedure proceeds to step S12. Instead of proceeding to step S15 in the event that a remaining quantity alarm has been received from all the 1st to n-th physical ports, provision may be made to dispose of the frame if the value of the user priority of the frame indicates preferential disposal.

If it is ascertained at step S12 that a remaining quantity alarm for the queue of the priority class corresponding to the user priority indicated in the VLAN tag header of the input frame has not been received, the procedure proceeds to step S15. At step S15, the i-th physical port is selected as an output port. A switching tab for indicating the output port is attached to the frame, which is then supplied to the switch unit 23.

This provision can reduce congestion at a particular physical port in the trunk. In the embodiment described above, a description has been given of a case in which the queues provided for a physical output port are provided in one-to-one correspondence to the priority classes. Nonetheless, it should be noted that the number of priority classes may be one.

### Second Embodiment

The block diagram of the network switch apparatus according to the second embodiment is the same as FIG. 3. The queue utilization monitoring units 25, and 252 shown in FIG. 3 monitor the utilization rates of the queues 24₁ₐ through 24_{1c} and the queues 24₂ₐ through 24_{2c}, respectively. If the utilization rate of a queue of any priority class exceeds a second threshold that is larger than the first threshold, a back pressure is issued, and is reported with an indication of the priority class to the distribution processing unit 22. The function to generate a back pressure is one of the conventional functions provided in the queue utilization monitoring units. Upon being informed of a back pressure, the distribution processing unit 22 disposes of the input frame.

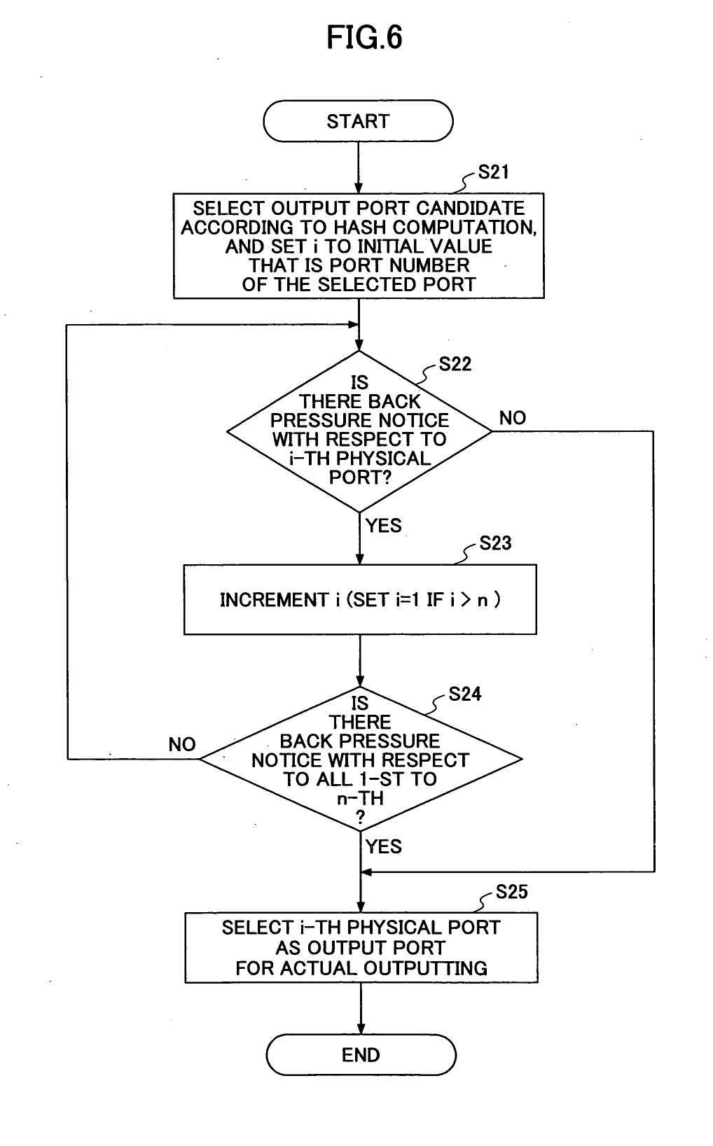

FIG. 6 is a flowchart showing a second embodiment of the distribution process performed by the distribution processing unit 22. This process is carried out each time a frame is input.

In FIG. 6, at step S21, Hash computation of the input frame is performed to derive an output port candidate. If link aggregation is put in place, n output ports are assigned to the result of the Hash computation. If one trunk is comprised of two physical ports, for example, n physical ports (n=2) are assigned as output ports.

The distribution processing unit 22 sets a variable i to the initial value that is the sequence number of the physical port selected as the output port candidate by the Hash computation.

At step S22, a check is made as to whether a back pressure notice for the queue of the priority class corresponding to the user priority indicated in the VLAN tag header of the input frame has been received from the queue utilization monitoring unit corresponding to the i-th physical port. If the back pressure notice has been received, the variable i is incremented (i=i+1) at step S23. If i becomes larger than n as a result of the incrementing, i is set to 1.

At step S24, a check is made as to whether a back pressure notice for the queue of the priority class corresponding to the user priority indicated in the VLAN tag header of the input frame has been received from all the 1st to n-th physical ports. If a back pressure notice has been received from all the 1st to n-th physical ports (i.e., from all the queue utilization monitoring units), the procedure proceeds to step S25. Otherwise, the procedure proceeds to step S22. Instead of proceeding to step S25 in the event that a back pressure notice has been received from all the 1st to n-th physical ports, provision may be made to dispose of the frame if the value of the user priority of the frame indicates preferential disposal.

If it is ascertained at step S22 that a back pressure notice for the queue of the priority class corresponding to the user priority indicated in the VLAN tag header of the input frame has not been received, the procedure proceeds to step S25. At step S25, the i-th physical port is selected as an output port. A switching tab for indicating the output port is attached to the frame, which is then supplied to the switch unit 23.

This provision can reduce congestion at a particular physical port in the trunk.

### Third Embodiment

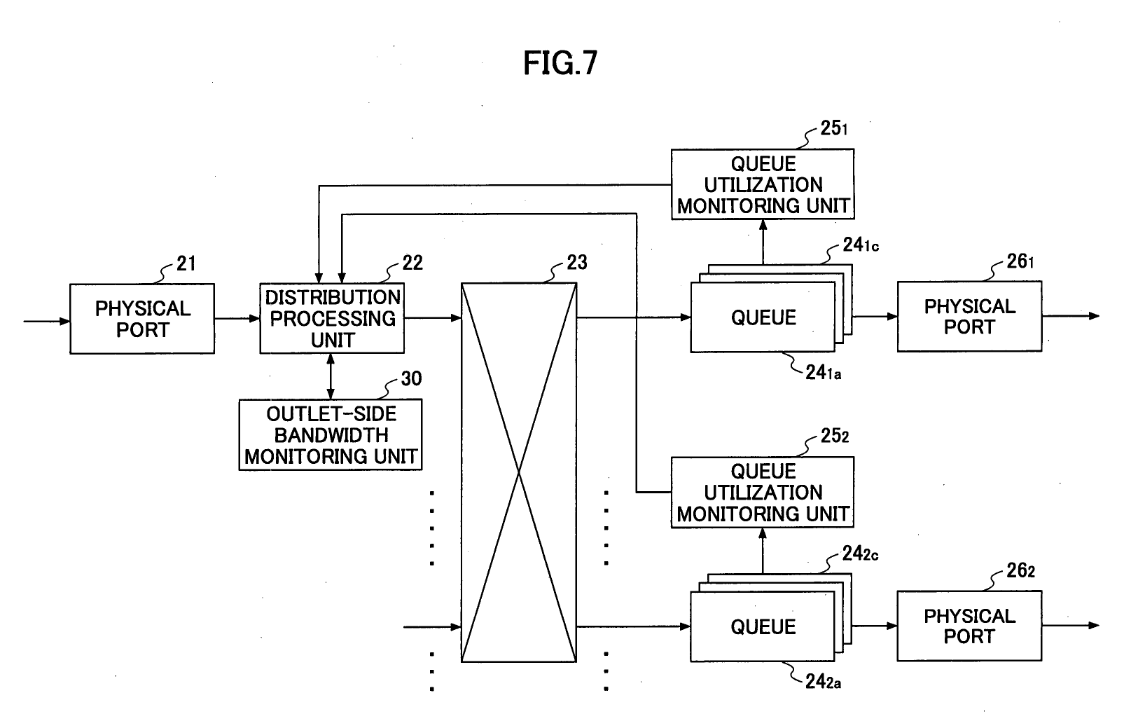

FIG. 7 is a block diagram showing a third embodiment of the network switch apparatus. In FIG. 7, the same elements as those of FIG. 3 are referred to by the same numerals.

In FIG. 7, the physical port 21 receives frames from an end user or another network switch apparatus. The physical port 21 supplies the received frames to the distribution processing unit 22. If the frames are supplied from the end user, the physical port 21 generates and attaches a VLAN tag. FIG. 7 illustrates only the physical port 21 as an input port. In actuality, however, a plurality of physical ports are provided as input ports.

The distribution processing unit 22 selects output ports by performing Hash computation on the input frames. The distribution processing unit 22 attaches to the frames a switching tag for indicating an output port, and supplies the frames to the switch unit 23. Further, the distribution processing unit 22 notifies an outlet-side bandwidth monitoring unit (output signal rate computing unit) 30 of the user priority, frame length, and selected output port of the input frames.

As a method for performing the Hash computation, a first method performs Hash computation with respect to a destination IP address and source IP address in the data area as well as DA-MAC and SA-MAC in the VLAN tag header format defined in IEEE802.1Q as shown in FIG. 4. A second method performs Hash computation with respect to VID of the VLAN tag header.

According the VLAN tag header format shown in FIG. 4, a 3-bit user priority, a 1-bit CFI, and a 12-bit VID are provided in the TCI of the VLAN tag. The user priority assumes values 6 and 7 to indicate the highest priority class, values 4 and 5 to indicate a high priority class, and values 0 through 3 to indicate a low priority class. Further, the values 6, 4, 2, and 0 indicate no preferential disposal, and the values 7, 5, 3, and 1 indicate preferential disposal.

When link aggregation configuration is implemented, a plurality of output ports are assigned with respect to the results of the. Hash computation described above. In FIG. 7, the two physical ports 26₁ and 26₂ are link-aggregated with respect to the results of predetermined Hash computation. In FIG. 7, only the physical ports 26₁ and 26₂ are illustrated as output ports. In reality, three or more physical ports are provided as output ports.

The outlet-side bandwidth monitoring unit 30 computes an output signal rate separately for each output port based on the information about the user priority, frame length, and selected output port of the input frames reported from the distribution processing unit 22. The computed output signal rate is reported to the distribution processing unit 22.

The switch unit 23 performs switching of frames by referring to the switching tags, and supplies the frames to queues provided separately for each of the physical output ports. The queues are provided in one-to-one correspondence to the plurality of priority classes. The frames supplied to the physical ports 26₁ and 26₂ by the switch unit 23 are queued in the queues 24₁ₐ through 24_{1c} and queues 24₂ₐ through 24_{2c} before being supplied to the physical ports 26₁ and 26₂.

The queues 24₁ₐ through 24₂ₐ serve to store frames having the highest priority class (e.g., audio data or the like). The queues 24_{1b} through 24_{2b} serve to store frames having the high priority class (e.g., business-purpose data or the like). The queues 24_{1c} through 24_{2c} serve to store frames having the low priority class (e.g., personal data or the like).

The frames queued in the queues 24₁ₐ through 24_{1c} are output from the physical port 26₁ in the descending order of priority classes (i.e., in the following order: 24₁ₐ, 24_{1b}, 24_{1c}). The same applies in the case of the other physical ports serving as output ports. When the frames are output from the physical ports, the switching tags attached to the frames by the distribution processing unit 22 are detached in one case, and are kept attached in another case for switching by switches at the subsequent stages.

The queues provided separately for each physical port are provided with a queue utilization monitoring unit. The queue utilization monitoring units 25₁ and 25₂ monitor the utilization rates of the queues 24₁ₐ through 24_{1c} and the queues 24₂ₐ through 24_{2c}, respectively. If the utilization rate of any priority class exceeds the second threshold, a back pressure is generated, and is reported with an indication of the priority class to the distribution processing unit 22.

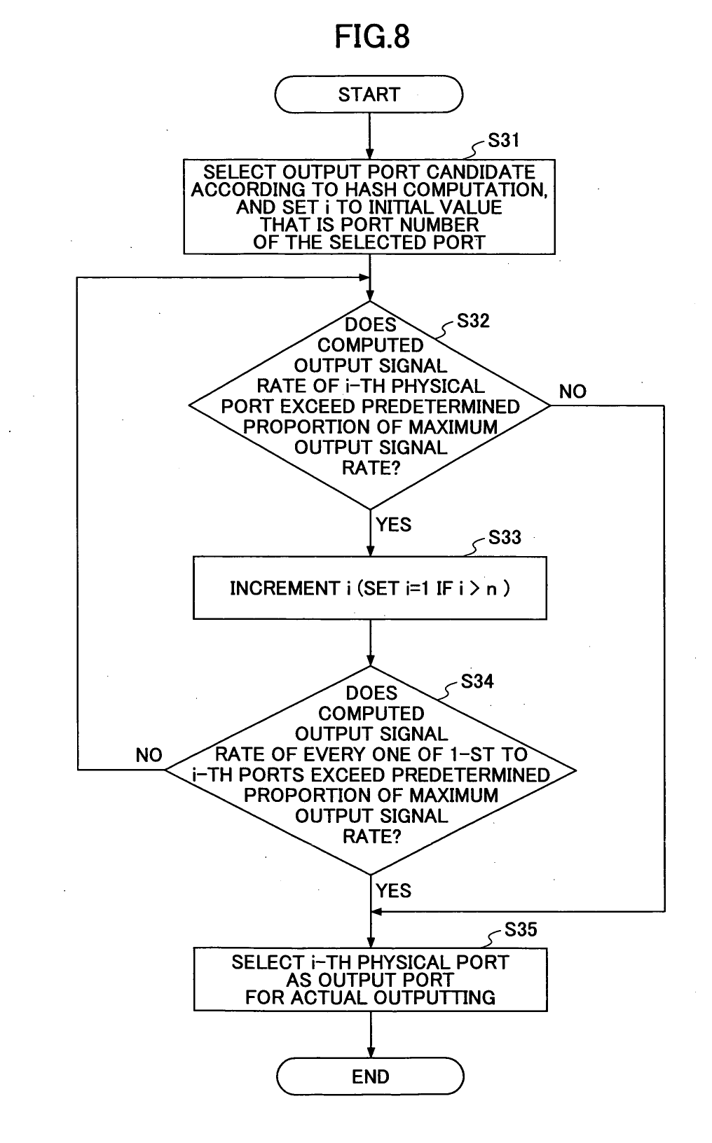

FIG. 8 is a flowchart showing a third embodiment of the distribution process performed by the distribution processing unit 22. This process is carried out each time a frame is input.

In FIG. 8, at step S31, Hash computation of the input frame is performed to derive an output port candidate. If link aggregation is put in place, n output ports are assigned to the result of the Hash computation. If one trunk is comprised of two physical ports, for example, n physical ports (n=2) are assigned as output ports. The distribution processing unit 22 sets a variable i to the initial value that is the sequence number of the physical port selected as the output port candidate by the Hash computation.

At step S32, a check is made as to whether an output signal rate computed by the outlet-side bandwidth monitoring unit 30 with respect to the i-th physical port exceeds a predetermined proportion (e.g., 80%) of the maximum output signal rate of that physical port. If the computed output signal rate exceeds the predetermined proportion, the variable i is incremented (i=i+1) at step S33. If i becomes larger than n as a result of the incrementing, i is set to 1.

At step S34, a check is made as to whether an output signal rate computed with respect to every single one of the 1^{st} to i-th physical ports exceeds the predetermined proportion of the maximum output signal rate. If the output signal rate exceeds the predetermined proportion with respect to every single one of the 1^{st} to i-th physical ports, the procedure proceeds to step S35. Otherwise, the procedure proceeds to step S32. Instead of proceeding to step S35 in the event that the output signal rate exceeds the predetermined proportion with respect to every single one of the 1^{st} to i-th physical ports, provision may be made to dispose of the frame if the value of the user priority of the frame indicates preferential disposal.

If it is ascertained at step 32 that the computed output signal rate does not exceed the predetermined proportion of the maximum output signal rate of the relevant physical port, the procedure proceeds to step S35. At step S35, the i-th physical port is selected as an output port. A switching tab for indicating the output port is attached to the frame, which is then supplied to the switch unit 23.

This provision can reduce congestion at a particular physical port in the trunk. In the embodiment described above, a description has been given of a case in which the queues provided for a physical output port are provided in one-to-one correspondence to the priority classes. Nonetheless, it should be noted that the number of priority classes may be one.

### Fourth Embodiment

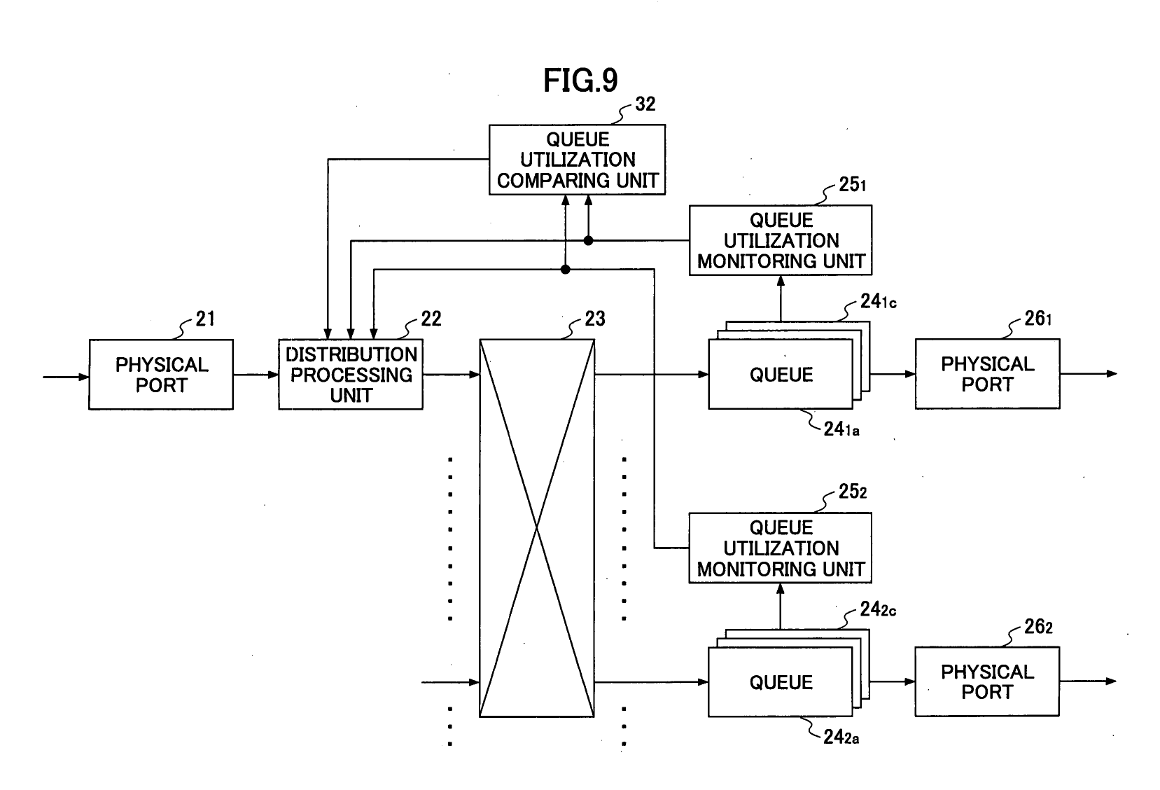

FIG. 9 is a block diagram showing a fourth embodiment of the network switch apparatus. In FIG. 9, the same elements as those of FIG. 3 are referred to by the same numerals.

In FIG. 9, the physical port 21 receives frames from an end user or another network switch apparatus. The physical port 21 supplies the received frames to the distribution processing unit 22. If the frames are supplied from the end user, the physical port 21 generates and attaches a VLAN tag. FIG. 9 illustrates only the physical port 21 as an input port. In actuality, however, a plurality of physical ports are provided as input ports.

The distribution processing unit 22 selects output ports by performing Hash computation on the input frames. The distribution processing unit 22 attaches to the frames a switching tag for indicating an output port, and supplies the frames to the switch unit 23.

As a method for performing the Hash computation, a first method performs Hash computation with respect to a destination IP address and source IP address in the data area as well as DA-MAC and SA-MAC in the VLAN tag header format defined in IEEE802.1Q as shown in FIG. 4. A second method performs Hash computation with respect to VID of the VLAN tag header.

According the VLAN tag header format shown in FIG. 4, a 3-bit user priority, a 1-bit CFI, and a 12-bit VID are provided in the TCI of the VLAN tag. The user priority assumes values 6 and 7 to indicate the highest priority class, values 4 and 5 to indicate a high priority class, and values 0 through 3 to indicate a low priority class. Further, the values 6, 4, 2, and 0 indicate no preferential disposal, and the values 7, 5, 3, and 1 indicate preferential disposal.

When link aggregation configuration is implemented, a plurality of output ports are assigned with respect to the results of the Hash computation described above. In FIG. 9, the two physical ports 26₁ and 26₂ are link-aggregated with respect to the results of predetermined Hash computation. In FIG. 9, only the physical ports 26₁ and 26₂ are illustrated as output ports. In reality, three or more physical ports are provided as output ports.

The switch unit 23 performs switching of frames by referring to the switching tags, and supplies the frames to queues provided separately for each of the physical output ports. The queues are provided in one-to-one correspondence to the plurality of priority classes. The frames supplied to the physical ports 26₁ and 26₂ by the switch unit 23 are queued in the queues 24₁ₐ through 24_{1c} and queues 24₂ₐ through 24_{2c} before being supplied to the physical ports 26₁ and 26₂.

The queues 24₁ₐ through 24₂ₐ serve to store frames having the highest priority class (e.g., audio data or the like) The queues 24_{1b} through 24_{2b} serve to store frames having the high priority class (e.g., business-purpose data or the like). The queues 24_{1c} through 24_{2c} serve to store frames having the low priority class (e.g., personal data or the like).

The frames queued in the queues 24₁ₐ through 241, are output from the physical port 26₁ in the descending order of priority classes (i.e., in the following order: 24₁ₐ, 24_{1b}, 24_{1c}). The same applies in the case of the other physical ports serving as output ports. When the frames are output from the physical ports, the switching tags attached to the frames by the distribution processing unit 22 are detached in one case, and are kept attached in another case for switching by switches at the subsequent stages.

The queues provided separately for each physical port are provided with a queue utilization monitoring unit. The queue utilization monitoring units 25₁ and 25₂ monitor the utilization rates of the queues 24₁ₐ through 24_{1c} and the queues 24₂ₐ through 24_{2c}, respectively. If the utilization rate of any priority class exceeds the second threshold, a back pressure is generated, and is reported with an indication of the priority class to the distribution processing unit 22. Further, the utilization rate of each queue is supplied to a queue utilization comparing unit 32.

The queue utilization comparing unit 32 compares, on a priority-class-by-priority-class basis, the queue utilization rates between the plurality of output ports assigned to the results of the Hash computation through link aggregation. The queue utilization comparing unit 32 notifies the distribution processing unit 22 of the output port having the lowest utilization rate with respect to each priority class. If the utilization rates of the queues 24₁ₐ through 24₂ₐ are 40% and 50%, respectively, for example, the queue utilization comparing unit 32 notifies the distribution processing unit 22 that the queue 24₁ₐ is the lowest output port.

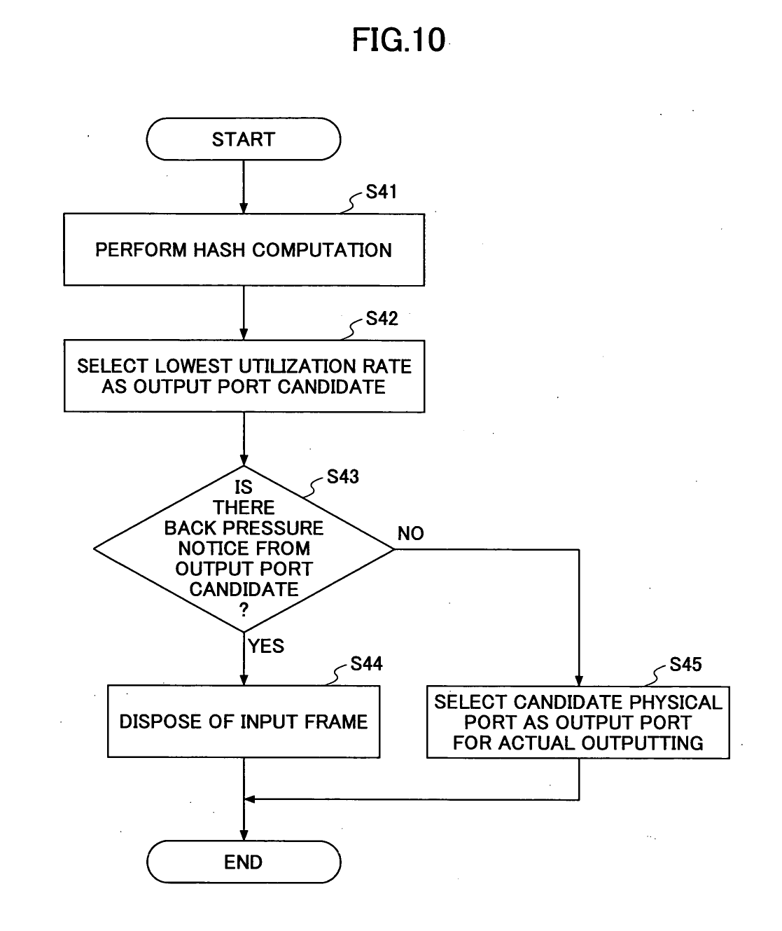

FIG. 10 is a flowchart showing a fourth embodiment of the distribution process performed by the distribution processing unit 22. This process is carried out each time a frame is input.

In FIG. 10, at step S41, Hash computation of the input frame is performed to derive an output port candidate. If link aggregation is put in place, n output ports are assigned to the result of the Hash computation. If one trunk is comprised of two physical ports, for example, n physical ports (n=2) are assigned as output ports.

At step S42, an output port candidate is determined by selecting the physical port reported from the queue utilization comparing unit 32 as having the lowest utilization rate among the n physical ports assigned as output ports. At step S43, a check is made as to whether a back pressure notice for the queue of the priority class corresponding to the user priority indicated in the VLAN tag header of the input frame has been received from the queue utilization monitoring unit corresponding to the candidate physical port.

If the back pressure notice has been received, the input frame is disposed of at step S44. If the back pressure notice has not been received, the candidate physical port is selected conclusively as an output port. A switching tag for indicating the selected output port is attached to the frame, which is then supplied to the switch unit 23.

This provision can reduce congestion at a particular physical port in the trunk. In the embodiment described above, a description has been given of a case in which the queues provided for a physical output port are provided in one-to-one correspondence to the priority classes. Nonetheless, it should be noted that the number of priority classes may be one.

Further, the present invention is not limited to these embodiments, but various variations and modifications may be made without departing from the scope of the present invention.

The present application is based on Japanese priority application No. 2005-236934 filed on Aug. 17, 2005, with the Japanese Patent Office, the entire contents of which are hereby incorporated by reference.

What is claimed is:

1. A network switch apparatus which receives data at physical input ports and outputs the data from a plurality of physical output ports which are link-aggregated, comprising:
a distribution processing unit configured to receive data input at one of the physical input ports and to assign the input data to one of the physical output ports for outputting therefrom such that said one of the physical output ports is determined according to part of the input data; and
a queue utilization monitoring unit configured to monitor a utilization rate of a queue provided separately for each of the physical output ports and to send an alarm to said distribution processing unit in response to the utilization rate of the queue exceeding a predetermined threshold,
wherein said distribution processing unit is configured to assign the input data to the one of the physical output ports for which said alarm is not reported.

2. The network switch apparatus as claimed in claim 1, wherein the queue provided separately for each of the physical output ports includes a set of queues provided in one-to-one correspondence to priority classes of data, and said queue utilization monitoring unit sends an alarm on a priority-class-specific basis, and wherein said distribution processing unit is configured to assign the input data to the one of the physical output ports for which said alarm is not reported with respect to the priority class of the input data.

3. The network switch apparatus as claimed in claim 1, wherein the alarm is a back pressure.

4. A network switch apparatus which receives data at physical input ports and outputs the data from a plurality of physical output ports which are link-aggregated, comprising:
a distribution processing unit configured to receive data input at one of the physical input ports and to assign the input data to one of the physical output ports for outputting therefrom such that said one of the physical output ports is determined according to part of the input data; and
an output signal rate computing unit configured to compute an output signal rate of said one of the physical output ports and to notify said distribution processing unit of the computed output signal rate,
wherein said distribution processing unit is configured to assign the input data to the one of the physical output ports for which said computed output signal rate is less than a predetermined proportion of a maximum output signal rate of said one of the physical output ports.

5. A network switch apparatus which receives data at physical input ports and outputs the data from a plurality of physical output ports which are link-aggregated, comprising:
a distribution processing unit configured to receive data input at one of the physical input ports and to assign the input data to one of the physical output ports for outputting therefrom such that said one of the physical output ports is determined according to part of the input data;
a queue utilization monitoring unit configured to monitor a utilization rate of a queue provided separately for each of the physical output ports; and
a queue utilization comparing unit configured to compare, between the physical output ports, the utilization rate of the queue reported from said queue utilization monitoring unit, and to notify said distribution processing unit of a physical output port having a lowest utilization rate,
wherein said distribution processing unit is configured to assign the input data to the one of the physical output ports that is the physical output port having the lowest utilization rate.

6. The network switch apparatus as claimed in claim 4, wherein the queue provided separately for each of the physical output ports includes a set of queues provided in one-to-one correspondence to priority classes of data, and said output signal rate computing unit computes an output signal rate of said one of the physical output ports on a priority-class-specific basis, and wherein said distribution processing unit is configured to assign the input data to the one of the physical output ports for which said computed output signal rate is less than the predetermined proportion of the maximum output signal rate with respect to the priority class of the input data.

7. The network switch apparatus as claimed in claim 5, wherein the queue provided separately for each of the physical output ports includes a set of queues provided in one-to-one correspondence to priority classes of data, and said queue utilization monitoring unit monitors the utilization rate of the queue on a priority-class-specific basis, and wherein said distribution processing unit is configured to assign the input data to the one of the physical output ports that is the physical output port having the lowest utilization rate with respect to the priority class of the input data.
